(19) United States
(12) Patent Application Publication
(10) Pub. No.: US 2023/0270186 A1
(43) Pub. Date: Aug. 31, 2023

(54) COLD WEATHER CLIMBING GARMENT

(71) Applicant: Marc A McAdams, Maryland, NY (US)

(72) Inventor: Marc A McAdams, Maryland, NY (US)

(21) Appl. No.: 17/681,760

(22) Filed: Feb. 26, 2022

(51) Int. Cl. A41D 13/00; A62B 35/00

(52) U.S. Cl. CPC A41D 13/0007; A62B 35/0075; A62B 35/0037

(57) ABSTRACT

A cold-weather garment for providing additional safety for those working on climbing of structures is presented. A safety harness to be combined with a cold-weather garment to provide for further safety and comfort of those who have a need for climbing structures. Furthermore, the safety harness shall further need to be coupled to a structure to promote further safety as well as be cost efficient and comfortable.

### FIELD OF THE INVENTION

This invention relates to garments. More particularly, it relates to garments for cold weather climbing.

### BACKGROUND

A safety harness is a form of protective equipment designed to safeguard the user from injury or death from falling. The core item of a fall arrest system, the harness is usually fabricated from rope, braided wire cable, or synthetic webbing. It is attached securely to a stationary object directly by a locking device or indirectly via a rope, cable, or webbing and one or more locking devices. Some safety harnesses are used in combination with a shock-absorbing lanyard, which is used to regulate deceleration and thereby prevent a serious G-force injury when the end of the rope is reached.

In North America, safety harnesses designed for protection against falls from heights in industrial and construction activities are covered by performance standards issued by the American National Standards Institute (ANSI) in the United States and by the Canadian Standards Association Group (CSA) in Canada. Specifically, the standards issued are ANSI Z359.1 and CSA Z259.10. These standards are updated approximately every four to five years.

Accordingly, and in light of the foregoing, there exist a need for a safety harness to be combined with a cold-weather garment to provide for further safety and comfort of those who have a need for climbing structures. Furthermore, the safety harness shall further need to be coupled to a structure to promote further safety as well as be cost efficient and comfortable.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front isometric view of a cold weather climbing garment 100, according to an embodiment of the present invention;

FIG. 2 is a front detail view of a cold weather climbing garment 100, according to an embodiment of the present invention;

FIG. 3 is a rear isometric view of a cold weather climbing garment 100, according to an embodiment of the present invention;

FIG. 4 is a rear detail view of a cold weather climbing garment 100, according to an embodiment of the present invention; and,

FIG. 5 is an in-use view of a cold weather climbing garment 100, according to an embodiment of the present invention.

### DESCRIPTIVE KEY

100 cold weather climbing garment
200 cold-weather garment
210 vest
212 jacket
220 safety harness
222 shoulder strap
224 left shoulder strap
226 right shoulder strap
228 crossover
230 dorsal D-ring
232 chest strap
234 leg straps
236 left leg strap
238 right leg strap
240 belt loop
242 belt
244 side D-ring
252 shoulder strap adjuster
254 left shoulder strap adjuster
256 right shoulder strap adjuster
258 chest strap adjuster
262 left leg adjuster
264 right leg adjuster
266 belt adjuster
270 shock absorbing lanyard
272 shock absorbing cord
274 lanyard clip
276 self-retracting lifeline
280 self-retractor body
282 retraction spring
284 speed brake
286 self-retractor cable
288 self-retractor clip
290 spool
408 vertical reflective strip
410 horizontal reflective strip
900 structure
950 user

### DESCRIPTION OF THE INVENTION

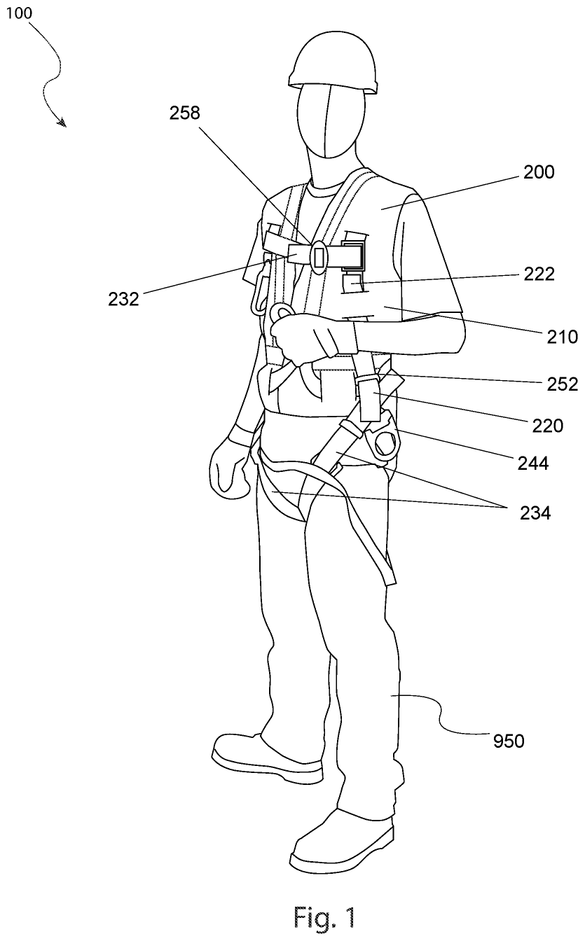

Referring to FIG. 1, the cold weather climbing garment 100 (hereinafter invention) comprises a cold-weather garment 200 and a safety harness 220 that a user 950 may don in cold weather in preparation for climbing. As a non-limiting example, the cold-weather garment 200 may be a vest 210. Shoulder straps 222, a chest strap 232, and leg straps 234 may be adapted to embrace and support the user 950 during a fall. Size adjusters 250 on the safety harness 220 may tighten and loosen the fit of the safety harness 220. As non-limiting examples, a chest strap adjuster 258 may adjust the fit of the chest strap 232 and shoulder strap adjusters 252 may adjust the fit of the shoulder straps 222. In some embodiments, side D-rings 244 coupled to the safety harness 220 may provide attachment points for a fall protection system.

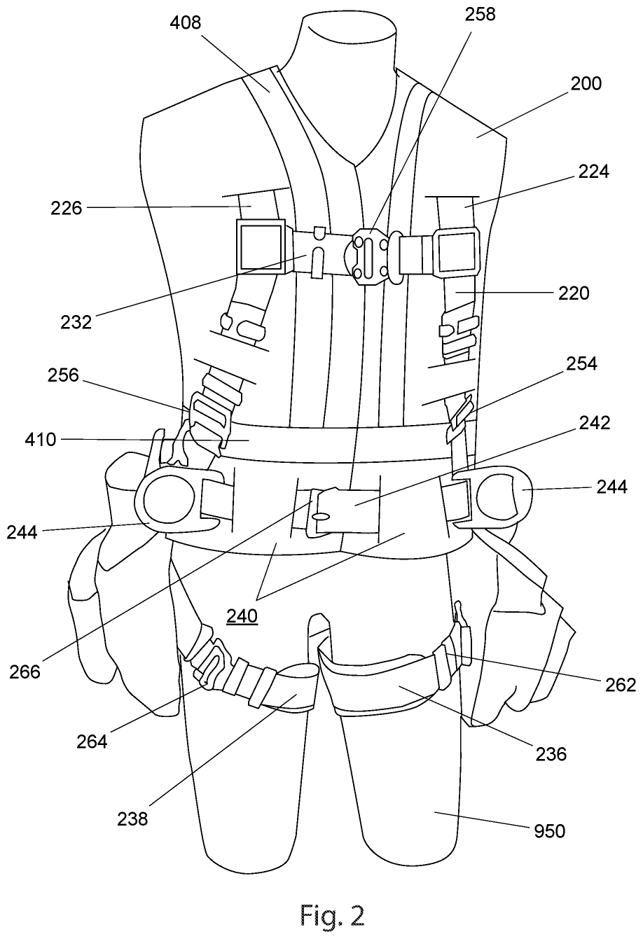

Turning to FIG. 2, the cold-weather garment 200 may be adapted to cover at least the torso of the user 950. The cold-weather garment 200 may be brightly colored to meet OSHA, ANSI, and other safety standards. As non-limiting examples, the cold-weather garment 200 may be yellow, orange, or strong yellow-green (in accordance with OSHA requirements) and may be fluorescent. If intended for use at night, the cold-weather garment 200 may be retroreflective yellow, orange, white, silver, or strong yellow-green (in accordance with OSHA requirements) and may be fluorescent. The reflectivity may make the cold-weather garment 200 visible in car headlights at a distance of one thousand feet (1000 ft.). The cold-weather garment 200 may comprise reflective strips that comply with ANSI Class 2 requirements. As non-limiting examples, vertical reflective strips 408 may be disposed on either side of the front of the cold-weather garment 200 oriented vertically from the waist to the shoulders and horizontal reflective strips 410 may be oriented to run horizontally across the lower half of the cold-weather garment 200.

The safety harness 220 may be sewn into the interior of the cold-weather garment 200 with portions of the safety harness 220 exposed to the exterior of the cold-weather garment 200 where necessary. As non-limiting examples, a left shoulder strap 224 and a right shoulder strap 226 may expose a left shoulder strap adjuster 254 and a right shoulder strap adjuster 256 on the exterior of the cold-weather garment 200. The left shoulder strap 224 and the right shoulder strap 226 may also expose couplings to the chest strap 232. The chest strap 232 may be exposed on the exterior of the cold-weather garment 200 such that the chest strap adjuster 258 may be accessible for donning and size adjustment.

The cold-weather garment 200 may comprise a plurality of belt loops 240 such that a belt 242 may weave through the cold-weather garment 200. The belt 242 may be operable to carry tools. In some embodiments, the side D-rings 244 may couple to the belt 242. A belt adjuster 266 may be exposed on the exterior front of the cold-weather garment 200 for donning and size adjustment.

The safety harness 220 may comprise a left leg strap 236 and a right leg strap 238 which may be operable to encircle the thigh to support the user 950 during a fall. The fit of the left leg strap 236 and the right leg strap 238 may be adjusted using a left leg adjuster 262 and a right leg adjuster 264, respectively.

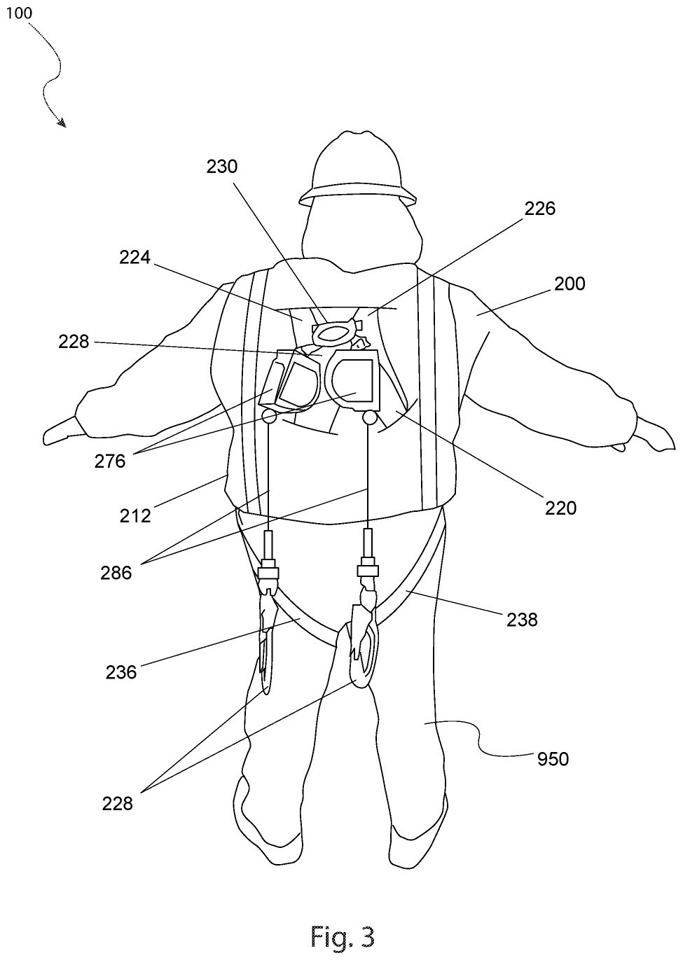

Moving now to FIG. 3, the invention 100 may be embodied as a jacket 212 with long sleeves and thicker thermal insulation for additional protection from cold-weather. The safety harness 220 may be sewn into the interior of the cold-weather garment 200 with portions of the safety harness 220 exposed to the exterior of the cold-weather garment 200 where necessary. As a non-limiting example, the left shoulder strap 224 and the right shoulder strap 226 may emerge from within the cold-weather garment 200, form a crossover 228 that may be accessible at the middle of the user's back, and may re-enter the cold-weather garment 200 below the crossover 228. The left shoulder strap 224 may be coupled to the right shoulder strap 226 where the left shoulder strap 224 and the right shoulder strap 226 overlap at the crossover 228, thus giving the crossover 228 increased strength. A dorsal D-ring 230 may be coupled to the crossover 228.

In some embodiments, one (1) or more self-retracting lifelines 276 may be coupled to the dorsal D-ring 230. Self-retractor clips 288 may be coupled to anchorage points on the structure that is being climbed with self-retractor cables 286 leading from the self-retractor clips 288 to the one (1) or more self-retracting lifelines 276. The one (1) or more self-retracting lifelines 276 may be fall arresters which may detect that a fall has occurred and may decelerate the user 950, bringing the user 950 to a stop suspended below the anchorage points of the structure. The left leg strap 236 and the right leg strap 238 may support most of the weight of the user 950 after the fall.

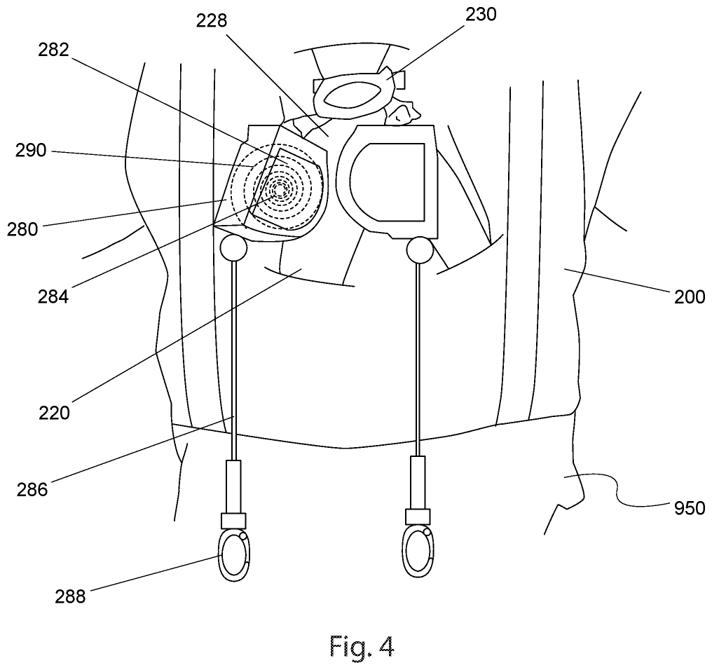

Referring to FIG. 4, an individual self-retracting lifeline may comprise the self-retractor clip 288, the self-retractor cable 286, and a self-retractor body 280. The self-retractor body 280 may detachably couple to the dorsal D-ring 230. The self-retractor body 280 may house a spool 290, a retraction spring 282, and a speed brake 284. The self-retractor cable 286 may wrap around the spool 290 when the self-retractor cable 286 is not deployed outside of the self-retractor body 280. The retraction spring 282 be may be operable to rotate the spool 290 to retract the self-retractor cable 286 such that the self-retractor cable 286 is kept taut at all times. The self-retractor clip 288 may be coupled to an anchorage point on the structure being climbed. When the user 950 falls while wearing the cold-weather garment 200 and the safety harness 220, the self-retractor cable 286 may be rapidly deployed from the spool 290. The speed brake 284 may sense a sudden increase in the speed of deployment of the self-retractor cable 286 and may activate to first slow and then stop the fall. The dorsal D-ring 230 may be coupled to the safety harness 220 at the crossover 228 and therefore the fall may leave the user 950 suspended below the anchorage point until rescued.

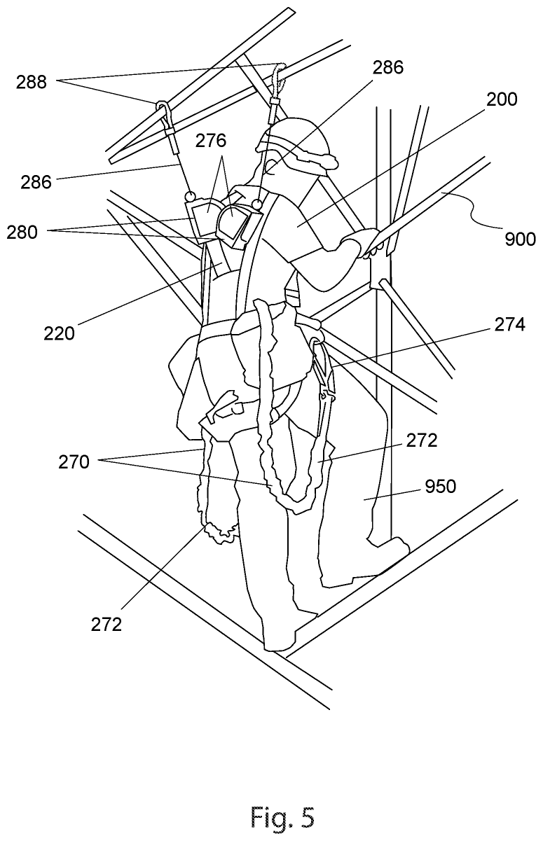

Moving to FIG. 5, a user 950 wearing a cold-weather garment 200 with a safety harness 220 and climbing on a structure 900 may couple self-retractor clips 288 from one (1) or more self-retracting lifelines 276 to anchorage points on the structure 900. Self-retractor cables 286 may be kept taut between the self-retractor clips 288 and self-retractor bodies 280 as the user 950 moves around on the structure 900. In this non-limiting example, the user 950 may also have one (1) or more shock absorbing lanyards 270 available to couple between the structure 900 and the side D-rings of the safety harness 220. An individual shock-absorbing lanyard may comprise a shock absorbing cord 272 and a lanyard clip 274. The shock absorbing cord 272 may extend between the side D-ring and the lanyard clip 274. The lanyard clip 274 may couple to the structure 900. The one (1) or more shock absorbing lanyards 270 may arrest a fall, although with more sudden deceleration than the one (1) or more self-retracting lifelines 276 may provide to the user 950. As non-limiting examples, the self-retractor clips 288 and the lanyard clips 274 may be OSHA-compliant carabiners.

The exact specifications, materials used, and method of use of the invention 100 may vary upon manufacturing. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A cold-weather climbing garment for providing protection in cold weather climbing, the climbing garment comprising:
a cold-weather garment, the cold-weather garment comprising:
a plurality of sleeves;
an interior and an exterior, the cold-weather garment being brightly colored and the cold-weather garment being made of a reflective color; and
a safety harness, the safety harness comprising:
a left shoulder strap and a right shoulder strap;
a left shoulder strap adjuster and a right shoulder strap adjuster, wherein the left shoulder strap adjuster and the right shoulder strap adjust being exposed on the exterior of the cold-weather garment;
a chest strap, the chest strap being exposed on the exterior of the cold-weather garment, wherein the chest strap configured to be accessible for donning and size adjustment
wherein the safety harness being sewn into the interior of the cold-weather garment.

2. The climbing garment of claim 1, wherein the cold-weather garment having a thermal insulation.

3. The climbing garment of claim 1, wherein the sleeves of the cold-weather garment being long sleeves.

4. The climbing garment of claim 1, wherein the cold-weather garment having one or more lifelines.

5. The climbing garment of claim 4, wherein the one or more lifelines being self-retracting.

6. The climbing garment of claim 4, wherein the one or more lifelines being coupled to a dorsal D-ring.

7. The climbing garment of claim 6 wherein D-ring being coupled to the safety harness at a crossover.

8. The climbing garment of claim 4, wherein the lifelines being coupled to a spool.

9. The climbing garment of claim 1, wherein the safety harness further comprises one or more lanyards, one or more clips and a cord.

10. The climbing garment of claim 9, wherein the cord being shock absorbent.

11. The climbing garment of claim 9, wherein the lanyards being coupled to a structure being climbed.

12. The climbing garment of claim 9, wherein the lanyards being OSHA compliant carabiners.

13. The climbing garment of claim 9, wherein the clips being OSHA compliant carabiners.

14. The climbing garment of claim 9, wherein the lanyards being coupled to the lanyards between the D-rings and clips.
